(19) United States
(12) Patent Application Publication
(10) Pub. No.: US 2004/0204142 A1
(43) Pub. Date: Oct. 14, 2004

(54) Method for showing caller's mood index in cellular phone and a cellular phone used in the method

(75) Inventor: James Chen, Hsinchu (TW)

Correspondence Address: BACON & THOMAS, PLLC, 625 SLATERS LANE, FOURTH FLOOR, ALEXANDRIA, VA, 22314

(73) Assignee: LITE-ON TECHNOLOGY CORPORATION, Taipei (TW)

(21) Appl. No.: 10/396,441

(22) Filed: Mar. 26, 2003

(30) Foreign Application Priority Data
Nov. 26, 2002 (TW) 091134294

(51) Int. Cl. H04M 1/00

(52) U.S. Cl. 455/566; 455/575.1

(57) ABSTRACT

The present invention relates to a method for showing a caller's mood index in a cellular phone, which comprises the steps of establishing a mood index database in the cellular phone, storing the caller's birth month and day in the cellular phone, checking the caller's mood index according to a caller's birth month and day and current date by inquiring a mood index database stored in the cellular phone, and finally, displaying a picture representing the caller's mood index on the screen of the cellular phone.

The present invention also relates to a cellular phone displaying caller's mood index on a screen thereof. Therefore, the cellular phone according to the present invention can be more interesting on phone communication.

### FIELD OF THE INVENTION

The present invention relates to a method for showing a caller's mood index in a cellular phone and a cellular phone displaying a caller's mood index. In particularly, the present invention relates to a method for showing a caller's mood index in a cellular phone in which the index is displayed as a picture and a cellular phone using this method.

### TECHNICAL BACKGROUND

It is a great improvement recently on cellular phone in regard to modeling, function, and display style. New cellular phone is always designed to cater for the customer's requirements. Today, cellular phone is not simply used for communication. Therefore, various ring, color, shape and picture styles have been developed.

Therefore, if pictures displayed on the screen of a cellular phone are designed to be vivid and interesting, the cellular phone will be more popular.

### SUMMARY OF THE INVENTION

One object of the present invention is to provide a method for showing a caller's mood index in a cellular phone, the method comprises the steps of establishing a mood index database in the cellular phone, storing the caller's birth month and day in a the cellular phone, checking the caller's mood index according to a caller's birth month and day and current date by inquiring a mood index database established in the cellular phone, and displaying pictures representing the caller's mood index on the screen of the cellular phone. Therefore, the cellular phone according to the present invention can be more interesting and popular.

The other object of the present invention is to provide a cellular phone showing a caller's mood index therein, only a mood index database is needed to be established in the cellular phone so that it doesn't increase the weight of the cellular phone.

These objects and the other objects, features, and advantages will be apparent to those people skilled in the art from the following detailed description in connection with the drawings.

### BRIEF DESCRIPTION OF THE DRAWINGS

FIG. 1 is a circuit block diagram showing a structure of a cellular phone with a mood index database according to an embodiment of the present invention;

FIG. 2 is a flow chart showing the procedures for adding a new data in a cellular phone according to an embodiment of the present invention;

FIG. 3 is a flow chart showing the procedures for activating or deactivating the method for showing a caller's mood index in a cellular phone according to an embodiment of the present invention;

FIG. 4 is a flow chart showing the operation procedures for showing a caller's mood index as a picture in a cellular phone according to an embodiment of the present invention;

FIG. 5 shows pictures corresponding to each step in FIG. 4; and

Table 1 lists one example of a database of daily mood index based on horoscope.

### DETAILED DESCRIPTION OF THE INVENTION

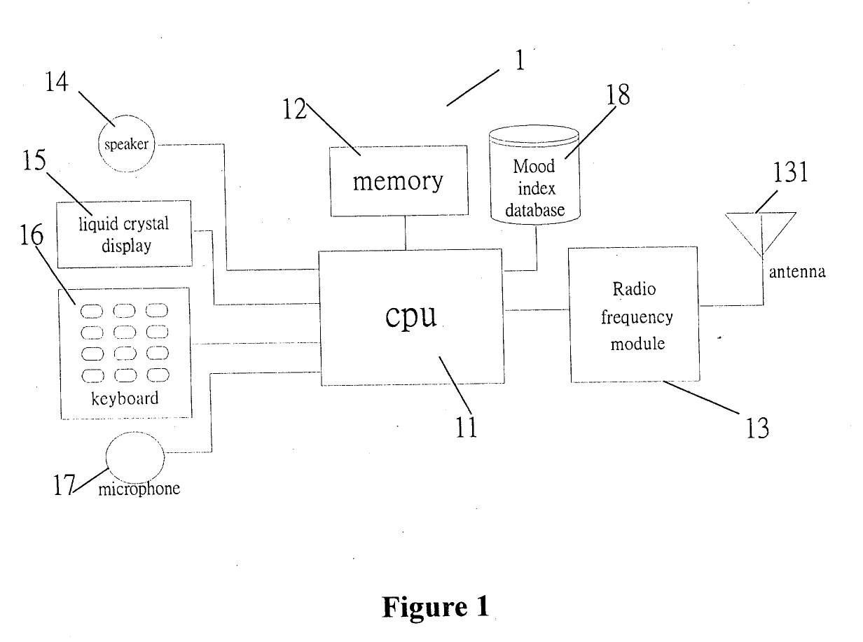

First of all, please refer to FIG. 1. FIG. 1 shows the circuit structure of the cellular phone performing the method for showing a caller's mood index in a cellular phone according to an embodiment of the present invention. From the FIG. 1, it is known that the present cellular phone 1 mainly comprises a central processing unit (CPU) 11, memory 12, radio frequency module 13, antenna 131, speaker 14, liquid crystalline displaying (LCD) screen 15, keyboard 16, and microphone 17. Additionally, the cellular phone according to the present invention further includes a mood index database 18 installed therein. The mood index database 18 is used for being inquired about mood indexes. The entirely procedures for checking a caller's mood index are as follows. A user first stores the caller's birth month and day in the memory 12. The central processing unit 11 inquires about the caller's mood index stored in the mood index database 18 according to the caller's birth month and day and a current day. Then a picture for representing the caller's mood index is displayed on the screen 15 of the cellular phone.

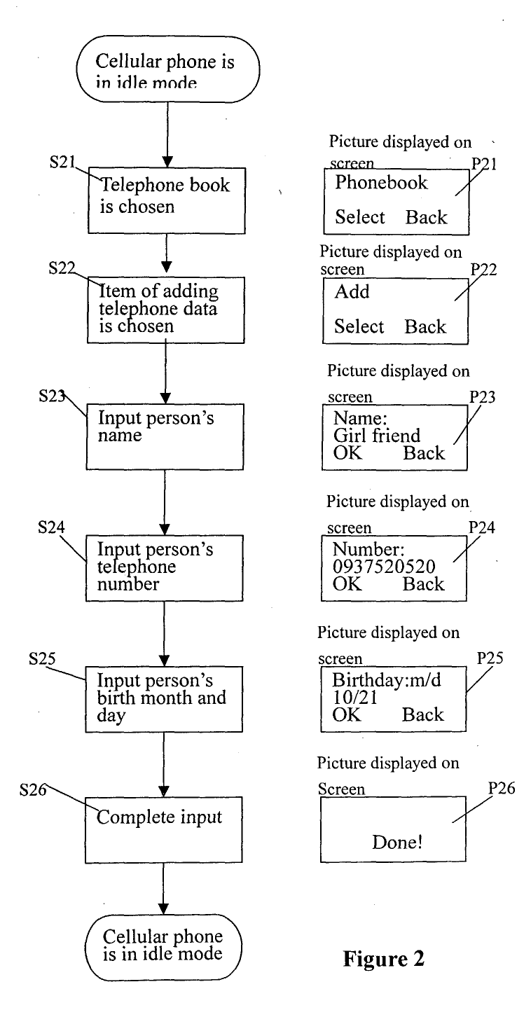

Next, please refer to FIG. 2. FIG. 2 is a flow chart showing steps for adding new data in a cellular phone, in which a picture displayed on the screen accompanied with the each corresponding step is also shown in the figure. The steps for adding new data in the cellular phone are as follows. First, the cellular phone is in idle mode. When a user wants to add a new telephone data, he chooses a telephone book function in the cellular phone (step S21, picture P21), and then select item of adding telephone data (step S22, picture P22). Thereafter, the user inputs a person's name to be added (step S23, picture P23: Girl Friend) and then inputs the person's telephone number (step S24, picture P24: 0937520520) and finally inputs the birth month and day of the person (step S25, picture P25: 10/21). After completing the data input (step S26, picture P26), the cellular phone is back to be in idle mode.

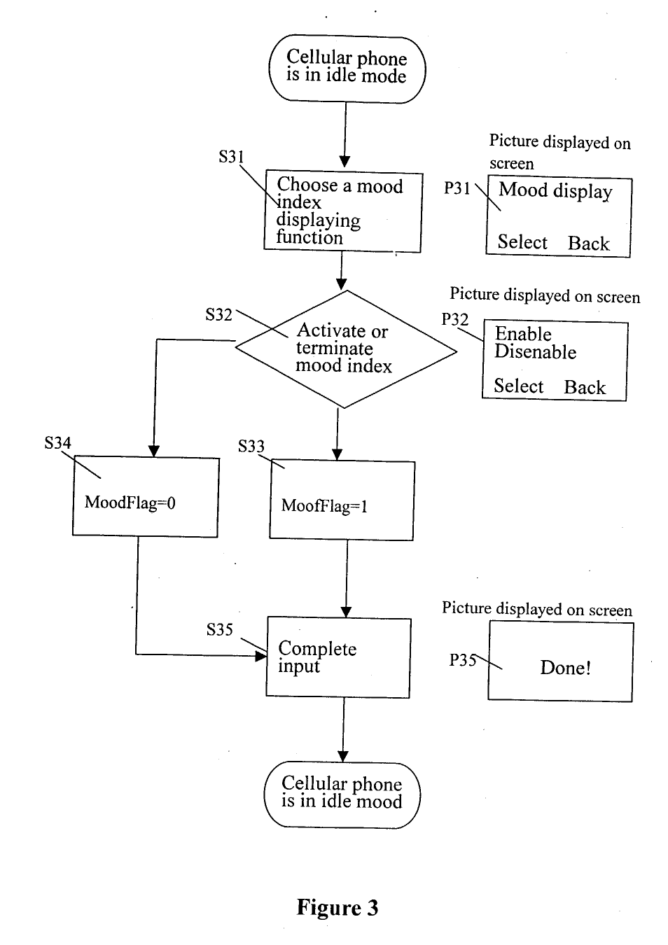

Now refer to FIG. 3. FIG. 3 is a flow chart showing steps for either activating or deactivating the function showing a caller's mood index, in which a picture displayed on the screen accompanied with the each corresponding step is also shown in the figure. First, a cellular phone is in idle mode. The user chooses a mood index displaying function (step S31, picture P31) to either activate or terminate the function for showing mood index (step S32, picture P32: Enable, Disable). If select to activate the function (Enable), a flag Horoscope F shows as 1. If select to terminate the function (Disable), a flag Horoscope F shows as 0. After completing the input (step S35, picture P35), the cellular phone is back to idle mode.

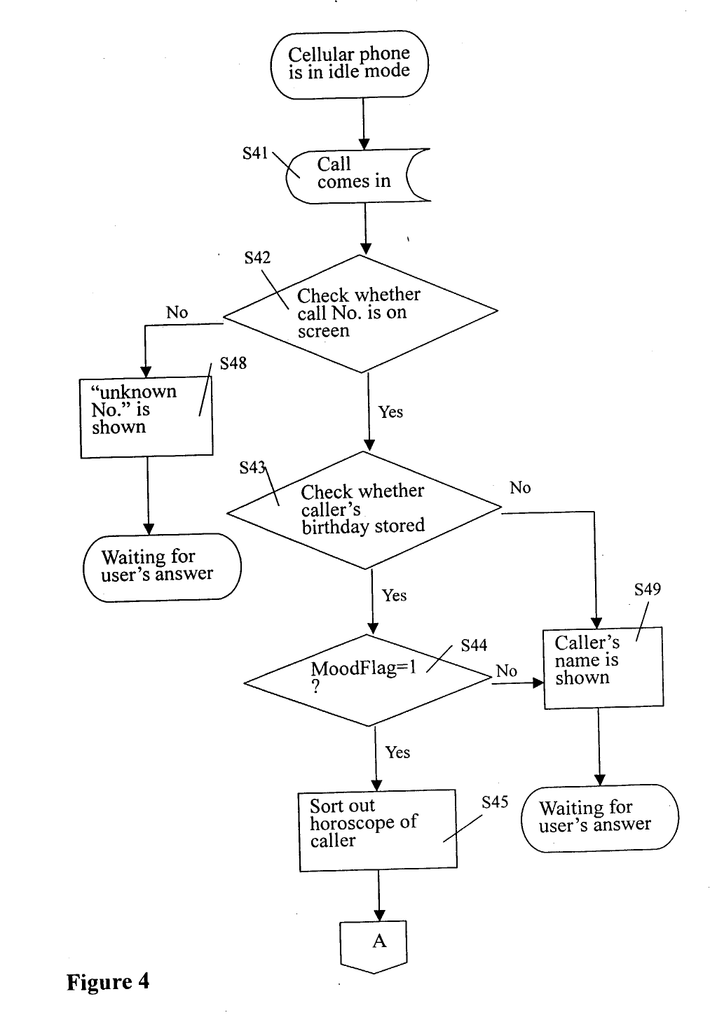

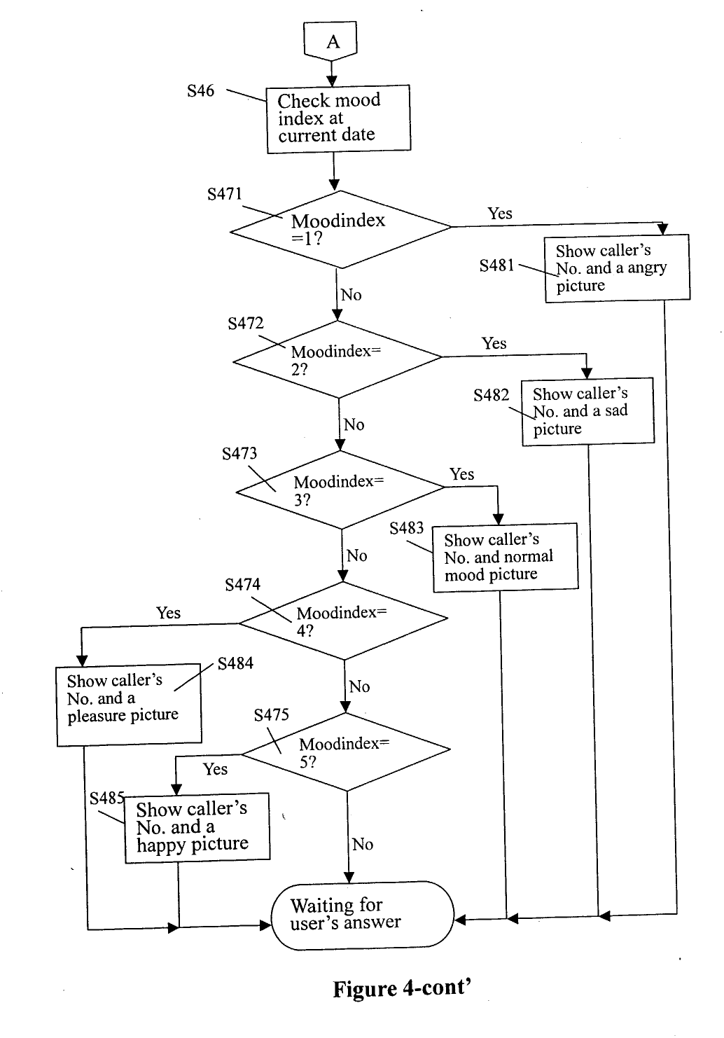

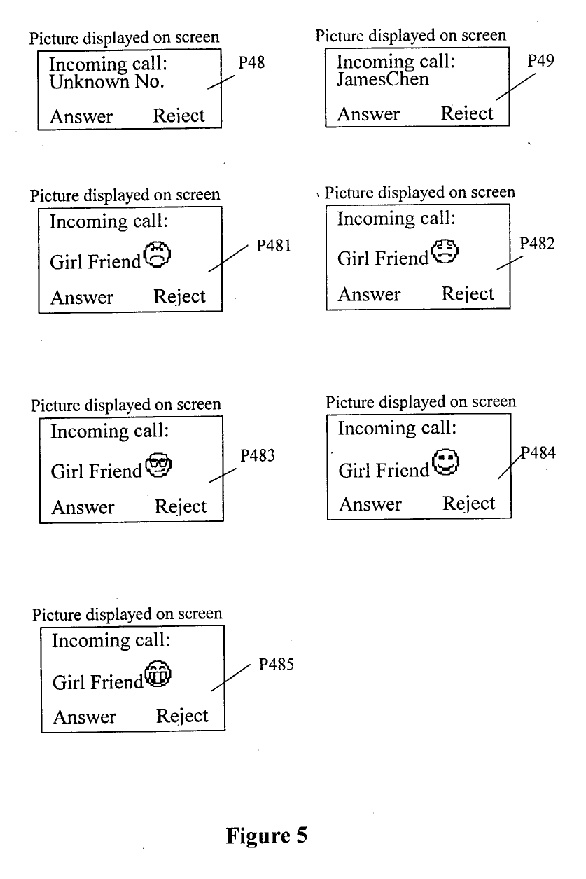

Finally, please refer to FIG. 4. FIG. 4 is a flow chart showing the operation steps of the method for showing a caller's mood index in a cellular phone. First, when a phone call comes in (step S41), a cellular phone first checks whether a telephone number is shown in the screen (step S42). If not, message “unknown number” is directly shown on the screen (step S48, picture P48: “Unknown number” as shown in FIG. 5) to wait for user answering the phone. If so, the cellular phone further checks whether the birthday of the caller has been stored in the memory (step S42). If not, only the caller's name is shown on the screen (step S49, picture P49: James Chen, as shown in FIG. 5) and also to wait for the user answering the phone. If so, the cellular phone checks whether the function flag Horoscope F is 1(step 44). If not, it means that the mood index function is not activated, thus the cellular phone turns to step S49 to show the caller's name only. If so, the horoscope of the caller can be chosen from the database according to the caller's birth month and day(step S45) and then check its mood index according to the current date (step S46). Subsequently, the database checks whether the mood index is 1 (step S471). If so, the caller's number and an angry picture are shown on the screen (step S481; picture P481: [symbol] as shown in FIG. 5). If not, the database further checks whether the mood index is 2 (step S472). If so, the caller's number and a sad picture are shown on the screen (step S482; picture P482: [symbol] as shown in FIG. 5). If not, the database further checks whether the mood index is 3 (step S473). If so, the caher's number and a normal mood picture are shown on the screen (step S483; picture P483: [symbol] as shown in FIG. 5). If not, the database further checks whether the mood index is 4 (step S474). If so, the caller's number and a pleasure picture are shown on the screen (step S484; picture P484: [symbol] as shown in FIG. 5). If not, the database further checks whether the mood index is 5 (step S475). If so, the caller's number and a happy picture are shown on the screen (step S485; picture P485: [symbol] as shown in FIG. 5 ). The user could wait to answer the call while the picture being displayed.

Table 1 lists one example of database of daily mood index based on horoscope. Of course, the picture showing the mood index is not limited in the above-mentioned five pictures, the other picture such as showing tension and scare mood can be included.

Although the present invention has been described by the above embodiment, the present invention is not limited by the embodiment. Person skilled in the art would make various changes or modification without departing from the spirit and the scope of the present invention. The present invention is only limited by the appended claims.

TABLE 1

| Month/Day | 1/1 | 1/2 | 1/3 | 12/30 | 12/31 |
|---|---|---|---|---|---|
| Aquarius | 1 | 2 | 4 | 1 | 5 |
| 1/21-2/19 | | | | | |
| Pisces | 2 | 3 | 5 | 2 | 3 |
| 2/20-3/20 | | | | | |
| Aries | 3 | 1 | 1 | 3 | 1 |
| 3/21-4/20 | | | | | |
| Taurus | 4 | 2 | 2 | 4 | 2 |
| 4/21-5/21 | | | | | |
| Gemini | 5 | 3 | 1 | 5 | 3 |
| 5/22-6/21 | | | | | |
| Cancer | 1 | 4 | 2 | 1 | 4 |
| 6/22-7/23 | | | | | |
| Leo | 2 | 5 | 3 | 2 | 5 |
| 7/24-8/23 | | | | | |
| Virgo | 3 | 1 | 4 | 3 | 1 |
| 8/24-9/23 | | | | | |
| Libra | 4 | 2 | 5 | 4 | 2 |
| 9/24-10/23 | | | | | |
| Scorpio | 5 | 3 | 1 | 5 | 3 |
| 10/24-11/22 | | | | | |
| Sagitta | 1 | 4 | 2 | 1 | 4 |
| 11/23-12/22 | | | | | |
| Capricorn | 2 | 5 | 3 | 2 | 5 |
| 12/23-1/20 | | | | | |

What is claim is:

1. A method for showing a caller's mood index in a cellular phone, which comprises the steps of: establishing a mood index database in said cellular phone; storing a caller's birth month and day in said cellular phone; checking a caller's mood index according to said caller's birth month and day and a current date by inquiring a mood index database stored in said cellular phone; and displaying a picture for representing the caller's mood index on a screen of said cellular phone.

2. The method according to claim 1, when a user adds new friend's data in said cellular phone, a friend's birthday can be also added and stored.

3. The method according to claim 1, wherein the database checks the caller's birth month and day to select what horoscope the caller belongs to then check its mood index according to a current date.

4. The method according to claim 1 or 3, wherein the mood index is shown as a number.

5. The method according to claim 4, wherein said number is 1, 2, 3, or 4; the number 1 represents angry mood, 2 represents sad mood, 3 represents normal mood, 4 represents pleasure mood, and 5 represents happy mood.

6. The method according to claim 1, wherein the mood index is shown in one of following pictures: “ [symbol] ”, “ [symbol] ”, “ [symbol] ”, “ [symbol] ”, and “ [symbol] ”; the “ [symbol] ” represents angry mood, “ [symbol] ” represents sad mood, “ [symbol] ” represents general affection mood, “ [symbol] ” represents pleasure mood, and “ [symbol] ” represents happy mood.

7. A cellular phone capable showing a caller's mood index, which comprises a central processing unit (CPU), memory, radio frequency module, displaying screen, keyboard, speaker, microphone, and antenna; the cellular phone is characterized in that the cellular phone further includes a mood index database, said database is used for storing a caller's name, telephone number, and birthday, and said central processing unit inquires a mood index stored in said database according to said caller's birth month and day.

8. The cellular phone according to claim 7, wherein said mood index is displayed as a picture on said displaying screen.

9. The cellular phone according to claim 7, wherein the function of showing mood index is activated or deactivated by a user.

10. The cellular phone according to claim 7, wherein the central processing unit can process the following logic judgment:
(1) checking whether a caller's phone number is displayed on said screen;
(2) checking whether a caller's birthday is stored in said database; and
(3) activating a function for showing said caller's mood index.

11. The cellular phone according to claim 10, wherein said function for showing mood index is operated by the following procedures: checking said caller's birth month and day to select what horoscope said caller belongs to and then check said mood index according to a current date, and displaying a picture representing a mood index on said displaying screen.
